(19) United States
(12) Patent Application Publication
(10) Pub. No.: US 2014/0313560 A1
(43) Pub. Date: Oct. 23, 2014

(54) OPTICAL PHASED ARRAY

(71) Applicant: The Australian National University, Australian Capital Territory (AU)

(72) Inventor: Daniel Anthony Shaddock, Kaleen (AU)

(21) Appl. No.: 14/370,312

(22) PCT Filed: Dec. 21, 2012
(86) PCT No.: PCT/AU2012/001586

§ 371 Date: Jul. 2, 2014

(30) Foreign Application Priority Data
Jan. 4, 2012 (AU) 2012900034

(51) Int. Cl. G02F 1/29

(52) U.S. Cl. CPC G02F 1/292
USPC 359/239; 359/238

(57) ABSTRACT

An optical phased array (100) and a method (200) of forming an optical beam using an optical phased array (100) are disclosed. The optical phased array (100) comprises an optical head (116) for producing an output light beam, a spread spectrum modulation module (112), and a module (114) for controlling the phase of spread-spectrum-modulated light beams. The optical head (116) has a reference surface in the optical head (116) and comprises a number of sub-apertures (130) each for receiving a respective light beam. The reference surface (116) produces a backreflected light signal (126). The spread spectrum modulation module (112) modulates each of the light beams to have a spread spectrum signal for isolating the respective modulated light beam, which is provided to the optical head (116). The module (114) for controlling the phase of the spread-spectrum-modulated light beams is dependent upon the backreflected light signal (126) and the spread spectrum modulation.

### RELATED APPLICATION

The present application is entitled, for the purposes of the United States under 35 USC §119, to the earlier filing date of Australian Provisional Patent Application No. 2012900034 filed 4 Jan. 2012 in the name of The Australian National University, which is incorporated herein by reference in its entirety.

### TECHNICAL FIELD

The present invention relates generally to light sources and more particularly to optical beam steering systems.

### BACKGROUND

Phased arrays are well known in the field of radio-frequency (RF) engineering as a mechanism for controlling the direction of propagation and apparent source of origin of an electromagnetic field. Extending this technology beyond the RF band of the electromagnetic (EM) spectrum becomes increasingly difficult as the frequency of the EM radiation increases. This is because the ability to control the phase of the radiation becomes increasingly difficult as the wavelength becomes smaller and the frequency increases.

Methods to control the phase of optical-frequency, electromagnetic (EM) radiation are known. However, such optical beamforming devices all fail without a feedback control mechanism placed in the output beam path. Placing such a feedback control mechanism in the output beam has been necessary to measure and adjust for the inevitable variation in the optical path length (OPL) of the optical beamforming device that results from thermal and other sources. Disadvantageously, placing such a feedback control mechanism in the output beam necessarily diverts a portion of the output energy from its intended destination. Furthermore, the position of a sensor is required to be external to the optical beamforming device.

### SUMMARY

In accordance with an aspect of the invention, there is provided an optical phased array, comprising: an optical head for producing an output light beam, the optical head having a reference surface in the optical head and comprising a plurality of sub-apertures each for receiving a respective light beam, the reference surface producing a backreflected light signal; a spread spectrum modulation module for modulating each of a plurality of light beams to have a spread spectrum signal for isolating the respective modulated light beam, which is provided to the optical head; and means for controlling the phase of the spread-spectrum-modulated light beams dependent upon the backreflected light signal and the spread spectrum modulation.

The controlling means may be a phase correction module that adjusts an optical path length of each spread-spectrum-modulated light beam dependent upon the backreflected light signal and the spread spectrum modulation.

The optical phased array may further comprise a plurality of lasers for high power beam forming; and wherein the controlling means controls directly the phase of each laser.

The phase of each laser may be directly controlled by changing the frequency of the laser.

The controlled, spread-spectrum-modulated light beams are used in a feedback mechanism to effect control of the output light beam.

The output light beam is a high-powered light beam.

The phases of at least two spread-spectrum-modulated light beams are independently controlled dependent upon the backreflected light signal and the spread spectrum modulation. Alternatively, the spread spectrum modulation module may modulate with a unique code each light beam input to the spread spectrum modulation module to produce a uniquely identified light beam.

The spread spectrum modulation module may modulate with a single common code each light beam input to separate the signals from each sub-aperture, each subaperture signal having a different delay. The optical phased array may comprise a plurality of light sources producing a plurality of light beams input to the spread spectrum modulation module.

The optical phased array may comprise a digital signal processing system for deriving phase information dependent upon the backreflected light signal to provide a phase correction signal. The phase information may be used to feedback to the phase shift of each sub-aperture to give a desired beam steering/beam forming of the output light beam in the far field. The digital signal processing system may: utilize spread spectrum decoding techniques to isolate individually and measure the phases of signals from each sub-aperture in the backreflected light signal.

The optical phased array may comprise a photodetector for generating a digital signal dependent upon the backreflected light signal.

The optical phased array may comprise an interference and photodetection module for interfering the backreflected light signal on a photodetector and for digitising a signal obtained from the photodetector.

In accordance with a further aspect of the invention, there is provided a method of forming an optical beam using an optical phased array. The method comprises: modulating, using a spread spectrum modulation module, each of a plurality of light beams to have a spread spectrum signal for isolating the respective modulated light beam; producing an output light beam using an optical head from a plurality of the spread-spectrum-modulated light beams, the optical head having a reference surface in the optical head and comprising a plurality of sub-apertures each for receiving a respective one of the spread-spectrum-modulated light beams, the reference surface producing a backreflected light signal; and controlling the phase of the spread-spectrum-modulated light beams dependent upon the backreflected light signal and the spread spectrum modulation.

The controlling step may be implemented using a phase correction module that adjusts the optical path length of each spread-spectrum-modulated light beam dependent upon the backreflected light signal and the spread spectrum modulation.

The method may comprise: using a plurality of lasers for high power beam forming; and wherein the controlling step controls directly the phase of each laser.

The phase of each laser may be directly controlled by changing the frequency of the laser.

The controlled, spread-spectrum-modulated light beams are used in a feedback mechanism to effect control of the output light beam.

The output light beam is a high-powered light beam.

The phases of at least two spread-spectrum-modulated light beams may be independently controlled dependent upon the backreflected light signal and the spread spectrum modulation.

The modulating step may modulate with a unique code each light beam to produce a uniquely identified light beam. Alternatively, the modulating step may modulate with a single common code each light beam input to separate the signals from each sub-aperture, each subaperture signal having a different delay. The method may comprise a plurality of light sources producing a plurality of light beams input to a spread spectrum modulation module.

The method may comprise deriving, using a digital signal processing system, phase information dependent upon the backreflected light signal to provide a phase correction signal.

The phase information is used to feedback to the phase shift of each sub-aperture to give a desired beam steering/beam forming of the output light beam in the far field.

The digital signal processing system may: utilize spread spectrum decoding techniques to isolate individually and measure the phases of signals from each sub-aperture in the backreflected light signal.

The method may comprise generating a digital signal dependent upon the backreflected light signal.

The method as claimed may comprise interfering the backreflected light signal on a photodetector and digitising a signal obtained from the photodetector.

### BRIEF DESCRIPTION OF THE DRAWINGS

Embodiments of the invention are described hereinafter with reference to the drawings, in which:

FIG. 1 is a block diagram illustrating an optical phased array in accordance with an embodiment of the invention;

FIG. 2 is a high-level flow diagram illustrating a method of forming an optical beam using an optical phased array; and

FIG. 3 is a more detailed flow diagram illustrating further aspects of the method of FIG. 2.

### DETAILED DESCRIPTION

Methods of forming an optical beam using an optical phased array, systems, and optical phased arrays are disclosed. In the following description, numerous specific details, including particular light sources, modulation techniques and the like are set forth. However, from this disclosure, it will be apparent to those skilled in the art that modifications and/or substitutions may be made without departing from the scope of the invention. In other circumstances, specific details may be omitted so as not to obscure the invention

Where reference is made in any one or more of the accompanying drawings to steps and/or features, which have the same reference numerals, those steps and/or features have for the purposes of this description the same function(s) or operation(s), unless the contrary intention appears.

The embodiments of the invention are directed to optical phased arrays. An optical phased array (OPA) is a device that combines light from multiple sub-apertures to form a beam in a far field. By adjusting the relative phases of the sub-apertures, the characteristics of a light beam produced by the optical phased array can be modified, e.g. the light beam can be steered in the far-field, or the beam size can be modified (focussed/defocussed). Another application of OPAs is to combine multiple independent lasers to achieve ultra-high power beams.

Compared to microwave/radio frequency phased-arrays, a challenge in OPAs exists in the control of the relative phases of the sub-apertures. In RF systems, the relative phase can be set for example by fixing the path length of the conductors driving the emitters. In an optical system, the wavelength of the light is much smaller and naturally occurring fluctuations in path length make accurately setting the phase of the light at the emitters difficult. The embodiments of the invention extract phase information about the transmitted light, in particular measure the phase of the sub-apertures, and adjust the path length of light travelled to each sub-aperture, meaning light emitted from each sub-aperture, has a controlled phase relationship.

The readout technique uses spread spectrum modulation. The outgoing beam, or at least portions of the components used to form the beam, is phase modulated with pseudo-random codes. This modulation allows the signals from individual sub-apertures to be isolated for identification. The phase of the isolated signals may then be measured using, for example, heterodyne interferometry. The phase information may then be used to adjust the OPL and compensate for the unwanted variations in the OPL.

The embodiment of the invention described hereinafter eliminates the need for an external sensor and allows control of optical path length (OPL) variations of the optical beamforming device based solely on electromagnetic (EM) radiation that is inevitably reflected within the OPA, contributing no further diversion of energy from the intended target.

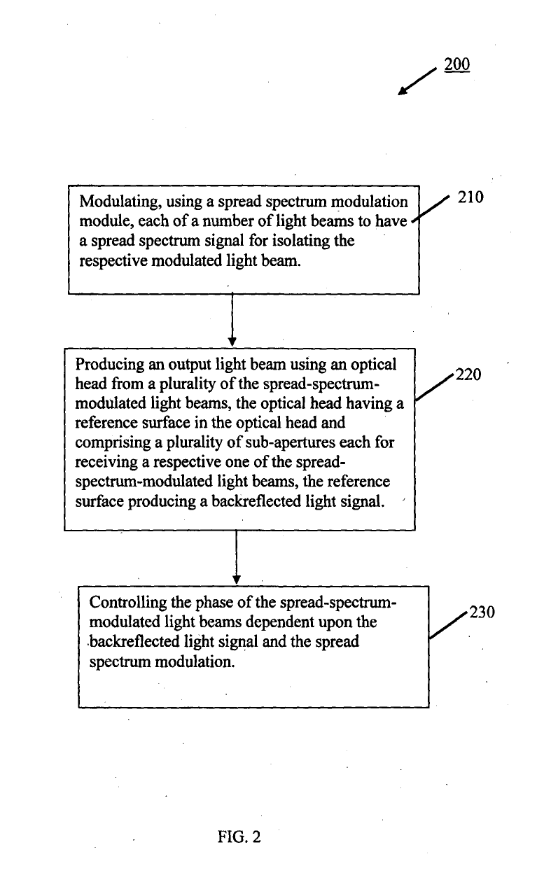

FIG. 2 illustrates at a high-level a method 200 of forming an optical beam using an optical phased array. In step 210, each of a number of light beams is modulated to have a spread spectrum signal for isolating the respective modulated light beam. In step 220, an output light beam is produced using an optical head from light beams. Either the light beam or at least a portion of each light beam transmitted via a sub-aperture is spread-spectrum-modulated. The light beams have at least a component that is spread spectrum modulated, which is used to effect control of the output beam, as explained hereinafter, and an unspread light beam. As used hereinafter, a “spread-spectrum-modulated light beam” is a light beam that has at least one component that is so modulated. The term is used to differentiate a light beam that has been processed by a spread spectrum modulation module in contrast to a light beam that has not been so processed. The optical head has a reference surface in the optical head and comprises a number of sub-apertures each for receiving a respective one of the spread-spectrum-modulated light beams. The reference surface produces a backreflected light signal. In step 230, the phases of the spread-spectrum-modulated light beams are controlled dependent upon the backreflected light signal and the spread spectrum modulation. The controlling step 230 may be implemented using a phase correction module that adjusts the optical path length of the spread-spectrum-modulated light beams dependent upon the backreflected light signal. Alternatively, a number of lasers may be used for high power beam forming, and the controlling step 230 may control directly the phase of each laser. Further, the phase of each laser may be directly controlled by changing the frequency of the laser.

The controlled, spread-spectrum-modulated light beams are used in a feedback mechanism to effect control of the output light beam.

The output light beam is a high-powered light beam.

The phases of two or more spread-spectrum-modulated light beams may be independently controlled dependent upon the backreflected light signal and the spread spectrum modulation.

Each light beam may be modulated with a unique code to produce a uniquely identified light beam. Alternatively, a single common code may be modulated with each light beam input to separate the signals from each sub-aperture, each sub-aperture signal having a different delay.

A number of light sources produce a number of light beams input to a spread spectrum modulation module.

Phase information is derived dependent upon the backreflected light signal to provide a phase correction signal. The phase information may be used to feedback to the phase shift of each sub-aperture to give a desired beam steering/beam forming of the output light beam in the far field.

A digital signal processing system may utilise spread spectrum decoding techniques to isolate individually and measure the phases of signals from each sub-aperture in the backreflected light signal.

A digital signal can be generated dependent upon the backreflected light signal.

The backreflected light signal may be interfered on a photodetector and digitising a signal obtained from the photodetector.

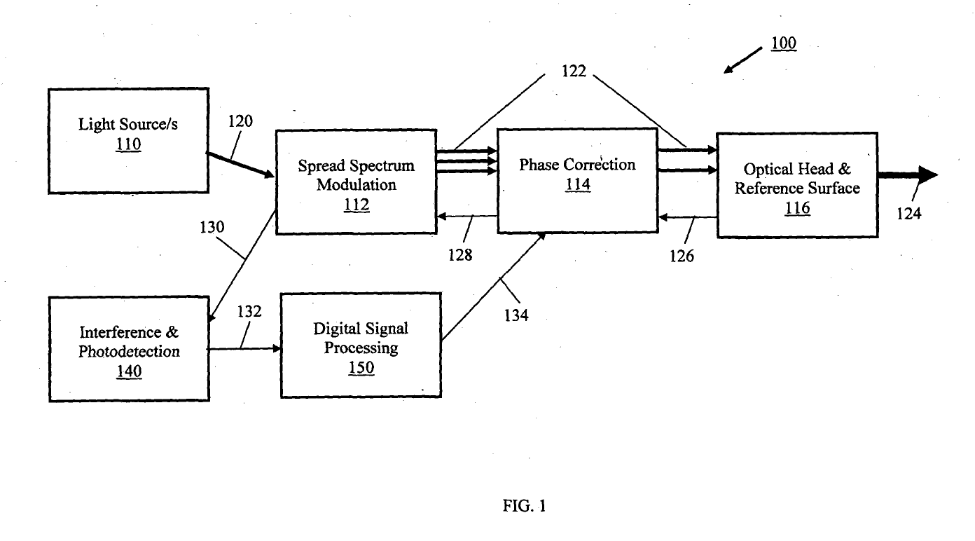

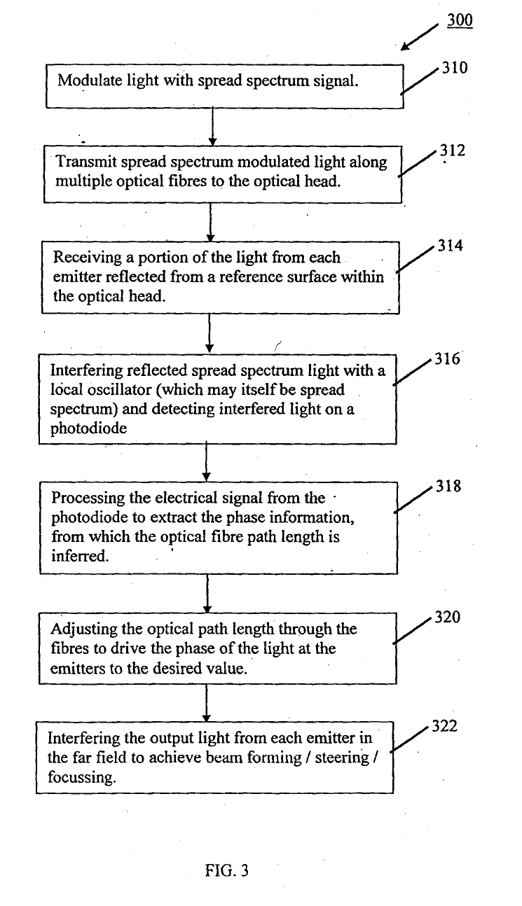

These and other details of the embodiments of the invention are described hereinafter with reference to FIGS. 1 and 3.

FIG. 1 illustrates an optical phased array (OPA) 100 in accordance with an embodiment of the invention. FIG. 3 illustrates a method 300 of forming an optical beam using the optical phased array 100 of FIG. 1.

A light source 110 in FIG. 1 comprises a number of light sources, e.g. several lasers, to provide light beams 120, which are input to a spread spectrum modulation module 112. The light source 110 could be a single laser source, or may contain multiple independent lasers, e.g. fibre lasers.

The method 300 commences processing in step 310. In step 310, the light beams from the light source 110 are each modulated with a spread spectrum signal. The spread spectrum modulation module 112 of FIG. 1 phase modulates each light beam or a component of each light beam with a unique code, so that each light beam can be uniquely identified. The modulation may comprise a binary phase shift keying (BPSK), or higher order phase shift keying, e.g. QPSK, 8-PSK. The modulation depth of the spread spectrum modulation may be low (<pi, or partial modulation), so that a significant fraction of the beam is unmodulated (the carrier light). The interference of this carrier light interferes in the far field to produce beam steering.

The outgoing light 122 produced by the spread spectrum modulation module 112 is passed to an optical head and reference surface 116. As shown in FIG. 1, the outgoing light 122 is passed through a phase correction module 114. As described hereinafter in detail, outgoing light 122 may be “phase corrected” by the phase correction module 114. In step 312 of FIG. 3, the spread-spectrum-modulated light beams, i.e. the outgoing light 122, are transmitted to the optical head 116. In one implementation, the transmission is implemented using optical fibres (not shown in FIG. 1) coupled to the optical head 116.

At the optical head 116, some portion 126 of the outgoing light 122 input to the optical head 116 is reflected from a reference surface of the optical head 116. The reference surface is a partially reflecting surface with a well-characterised surface profile and is typically the last surface that the light interacts with before exiting the optical beamforming device. This portion of the outgoing light of each sub-aperture 122 is backreflected light. The reference surface 116 is typically polished to be flat and samples a small fraction of the outgoing light 122, the remainder of which is the outgoing beam 124.

In step 314 of FIG. 3, a portion of the light from each emitter is reflected from the reference surface within the optical head 116, and this backreflected light is obtained or received.

As shown in FIG. 1, the backreflected light 126 is passed through the phase correction module 114 to provide an input signal 128 to the spread spectrum modulation module 112. The phase correction module 114 imparts the same phase shift on the outgoing light and the back-reflected light.

The spread spectrum modulation module 112 may or may not affect the phase of the back-reflected light depending on the detailed design of the modulation module 112 and the speed of the spread spectrum code. Optionally, the path 130 may be moved so that this path 130 is between the phase correction module 114 and the interference and photodetection module 140 (not shown in FIG. 1).

In step 316 of FIG. 3, the backreflected light is interfered with, and the interfered light is detected on a photodetector (e.g., a photodiode). The backreflected light with the spread spectrum signal is interfered with a local oscillator, which may itself be spread spectrum. In FIG. 1, the backreflected light from all sub-apertures 130 output by the spread spectrum modulation module 112 is output to an interference and photodetection module 140 and is interfered on a single photodetector of that module 140. The module 140 converts the optical power in path 130 to an electrical signal 132. The module 140 may interfere the backreflected light with an additional light field (local oscillator), or may utilise the existing interference between the optical fields from each sub-aperture.

In step 318, an electrical signal from the photodetection module 140 is processed to extract phase information, from which the optical path length of a light beam is inferred. The optical path length may be an optical fibre path length. The electrical signal obtained from the photodetector 140 is digitised and the resulting digital signal 132 is sent to a digital signal processing system 150, e.g. a field-programmable gate array (FPGA), for the processing in step 318. Inside the FPGA 150, spread spectrum decoding techniques are used to individually isolate the signals from each sub-aperture and so that their phases may be measured. Preferably, the spread spectrum decoding technique is “Digital Interferometry” disclosed in Shaddock, Daniel A., “Digitally enhanced heterodyne interferometry”, OPTICS LETTERS, Vol. 32, No. 22, pp. 3355-3357, 15 Nov. 2007, which is incorporated herein in its entirety by reference. Digital interferometry allows signals to be isolated by their time-of-flight (or equivalently delays) for the case of a single modulation code, or by code division multiplexing techniques for the case of using multiple modulation codes. The signals are extracted by multiplying the signal 132 by the same modulation code with an appropriate delay. Signals encoded using a different code or the same code with a different delay appear as broadband noise, which can be rejected by appropriate filtering. The purpose of this decoding step is to isolate the signal for subsequent determination of the phase of the signal from each sub-aperture, in contrast to the typical use of PRN modulation where the measurement output is the delay of the decoding signal needed to match the code delay of the input signal 132.

This phase information extracted or derived by the digital signal processing system 150 provides a phase correction signal 134 output to the phase correction module 114. In step 320 of FIG. 3, the optical path length through the optical fibres is adjusted to drive the phase of the light at the emitters to the desired value. Thus, the phase information is used to feedback to the phase shift of each sub-aperture to give the desired beam steering/beam forming in the far field.

The outgoing light 122 produced by the spread spectrum modulation module 112 is phase corrected by the phase correction module 114 before being transmitted to the optical head 116 of FIG. 1.

In step 322, the output light from each emitter is interfered in the far field to achieve beam forming/steering/focussing. This process 300 may be repeatedly carried out.

The OPA system 100 of FIG. 1 allows a light source to be steered without the need for a mechanical actuator. The architecture presented herein features an innovative method for reading out the relative phase of the light at the exit point of each sub aperture. This signal is used in a closed loop control system to steer the outgoing beam using electromagnetic interference. This same optical metrology system could be used to adjust the field of view when operated as a receiving device. Another use for the device is to drive each sub-aperture with a unique light source and then coherently combine the light sources in the far field by controlling the phase of each light source at the sub aperture. The real-time sensing and closed loop operation of the device overcomes the problems associated with maintaining a stable phase-difference between the light signals at the output of the sub-apertures.

An OPA 100 of FIG. 1 in accordance with the embodiment of the invention is advantageous, as follows:
Scalability: Many sub-apertures can be measured with only a single photodetector and digitisation system.
High power handling and beam quality: No additional optical components are needed on the outgoing (high-power) beam. All control signals are extracted on reflection.
Closed loop control: The digital interferometry phase measurement system provides a high sensitivity, full-range phase readout, allowing the beam to be commanded stably and accurately, e.g. over a wide range of angles.
The use of spread spectrum modulation may improve the robustness of the phase sensing in the presence of back scattered light (e.g. due to reflections at the interfaces between the modules) compared to conventional modulation schemes.

The embodiment of the invention has a number of applications including:

Defence: Laser targeting and weaponry and space debris tracking;

Communications: - free-space optical networks; and

Consumer electronics: laser displays and immersive holography.

The foregoing are merely examples and do not constitute an exhaustive list of possible applications of an OPA in accordance with embodiments of the invention.

The arrangements described are applicable to light sources and in particular to optical beamforming devices and systems.

Methods and systems for forming an optical beam using an optical phased array, and optical phased arrays have been described. The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. An open ended meaning is contemplated, instead of a close-ended expression such as “consisting of”. Variations of the word “comprising”, such as “comprise” and “comprises” have correspondingly varied meanings.

1. An optical phased array, comprising:
an optical head for producing an output light beam, said optical head having a reference surface in said optical head and comprising a plurality of sub-apertures each for receiving a respective light beam, said reference surface producing a light signal that is backreflected into one or more of said sub-apertures;
a spread spectrum modulation module for modulating each of a plurality of light beams to have a spread spectrum signal for isolating the respective modulated light beam, which is provided to said optical head; and
means for controlling the phase of the spread-spectrum-modulated light beams dependent upon said backreflected light signal and said spread spectrum modulation.

2. The optical phased array as claimed in claim 1, wherein the controlling means is a phase correction module that adjusts an optical path length of each spread-spectrum-modulated light beam dependent upon said backreflected light signal and said spread spectrum modulation.

3. The optical phased array as claimed in claim 1, comprising a plurality of lasers for high power beam forming; and wherein said controlling means controls directly the phase of each laser.

4. The optical phased array as claimed in claim 3, wherein the phase of each laser is directly controlled by changing the frequency of said laser.

5. The optical phased array as claimed in claim 1, wherein said controlled, spread-spectrum-modulated light beams are used in a feedback mechanism to effect control of said output light beam.

6. The optical phased array as claimed in claim 1, wherein said output light beam is a high-powered light beam.

7. The optical phased array as claimed in claim 1, wherein the phases of at least two spread-spectrum-modulated light beams are independently controlled dependent upon said backreflected light signal and said spread spectrum modulation.

8. The optical phased array as claimed in claim 1, wherein the spread spectrum modulation module that modulates with a unique code each light beam input to said spread spectrum modulation module to produce a uniquely identified light beam.

9. The optical phased array as claimed in claim 1, wherein said spread spectrum modulation module modulates with a single common code each light beam input to separate the signals from each sub-aperture, each sub-aperture signal having a different delay.

10. The optical phased array as claimed in claim 8, further comprising a plurality of light sources producing a plurality of light beams input to said spread spectrum modulation module.

11. The optical phased array as claimed in claim 1, further comprising a digital signal processing system for deriving phase information dependent upon said backreflected light signal to provide a phase correction signal.

12. The optical phased array as claimed in claim 11, wherein the phase information is used to feedback to the phase shift of each sub-aperture to give a desired beam steering/beam forming of the output light beam in the far field.

13. The optical phased array as claimed in claim 11, wherein said digital signal processing system:
utilizes spread spectrum decoding techniques to isolate individually and
measures the phases of signals from each sub-aperture in the backreflected light signal.

14. The optical phased array as claimed in claim 1, further comprising a photodetector for generating a digital signal dependent upon said backreflected light signal.

15. The optical phased array as claimed in claim 1, further comprising an interference and photodetection module for interfering said backreflected light signal on a photodetector and for digitising a signal obtained from the photodetector.

16. A method of forming an optical beam using an optical phased array, comprising:
modulating, using a spread spectrum modulation module, each of a plurality of light beams to have a spread spectrum signal for isolating the respective modulated light beam;
producing an output light beam using an optical head from a plurality of said spread-spectrum-modulated light beams, said optical head having a reference surface in said optical head and comprising a plurality of sub-apertures each for receiving a respective one of the spread-spectrum-modulated light beams, said reference surface producing a light signal that is backreflected into one or more of said sub-apertures; and
controlling the phase of the spread-spectrum-modulated light beams dependent upon said backreflected light signal and said spread spectrum modulation.

17. The method as claimed in claim 16, wherein the controlling step is implemented using a phase correction module that adjusts the optical path length of each spread-spectrum-modulated light beam dependent upon said backreflected light signal and said spread spectrum modulation.

18. The method as claimed in claim 16, comprising:
using a plurality of lasers for high power beam forming; and
wherein said controlling step controls directly the phase of each laser.

19. The method as claimed in claim 18, wherein the phase of each laser is directly controlled by changing the frequency of said laser.

20. The method as claimed in claim 16, wherein said controlled, spread-spectrum-modulated light beams are used in a feedback mechanism to effect control of said output light beam.

21. The method as claimed in claim 16, wherein said output light beam is a high-powered light beam.

22. The method as claimed in claim 16, wherein the phases of at least two spread-spectrum-modulated light beams are independently controlled dependent upon said backreflected light signal and said spread spectrum modulation.

23. The method as claimed in claim 16, wherein the modulating step modulates with a unique code each light beam to produce a uniquely identified light beam.

24. The method as claimed in claim 16, wherein the modulating step modulates with a single common code each light beam input to separate the signals from each sub-aperture, each sub-aperture signal having a different delay.

25. The method as claimed in claim 23, further comprising a plurality of light sources producing a plurality of light beams input to a spread spectrum modulation module.

26. The method as claimed in claim 16, comprising deriving, using a digital signal processing system, phase information dependent upon said backreflected light signal to provide a phase correction signal.

27. The method as claimed in claim 26, wherein the phase information is used to feedback to the phase shift of each sub-aperture to give a desired beam steering/beam forming of the output light beam in the far field.

28. The method as claimed in claim 26, wherein said digital signal processing system:
utilizes spread spectrum decoding techniques to isolate individually and measures the phases of signals from each sub-aperture in the backreflected light signal.

29. The method as claimed in claim 16, comprising generating a digital signal dependent upon said backreflected light signal.

30. The method as claimed in claim 16, comprising interfering said backreflected light signal on a photodetector and digitising a signal obtained from the photodetector.
